(19) United States
(12) Patent Application Publication
(10) Pub. No.: US 2009/0030830 A1
(43) Pub. Date: Jan. 29, 2009

(54) System and method of making trading markets using generalized trade reduction

(76) Inventors: Rica Gonen, Sunnyvale, CA (US); Mira Gonen, Petach Tikva (IL); Elan Y. Pavlov, Cambridge, MA (US)

Correspondence Address: Law Office of Robert O. Bolan, P.O. Box 36, Bellevue, WA, 98009, US

(21) Appl. No.: 11/881,694

(22) Filed: Jul. 27, 2007

(51) Int. Cl. G06Q 40/00

(52) U.S. Cl. 705/37

(57) ABSTRACT

An improved system and method is provided for making trading markets using generalized trade reduction. To do so, a trade reduction engine may be provided to turn the implementation of an individually rational and incentive-compatible mechanism of a market maker engine for single-valued traders making trades in a particular trading domain into an implementation of a budget balanced, individually rational and incentive-compatible mechanism that may bound the loss in social welfare. In general, the generalized trade reduction methods find procurement sets of traders and remove them in iterations until conditions of competition among remaining traders may be fulfilled for trading to occur. Advantageously, the present invention may support many applications for making trading markets using generalized trade reduction for both procurement-class domains and class domains.

### FIELD OF THE INVENTION

The invention relates generally to computer systems, and more particularly to an improved system and method for making trading markets using generalized trade reduction.

### BACKGROUND OF THE INVENTION

In many of the mechanisms for implementing a trading market, the market maker may attempt to maximize the goal of social welfare. Generally, social welfare may be defined as the total benefit to society. In the economics literature, social welfare may also be referred to as efficiency. When designing a mechanism for implementing a trading market, there are several key properties that are desirable to maintain. Some of the more important ones are individual rationality (“IR”)—to make it worthwhile for all traders to participate, incentive compatibility (“IC”)—to give incentive to traders to report their true value to the mechanism, and budget balance (“BB”)—not to run the mechanism on a loss. However, it is well known from Myerson R. B. and Satterthwaite M. A, Efficient Mechanisms for Bilateral Trading, Journal of Economic Theory, Volume 29, pages 265-281, 1983, that any mechanism that maximizes social welfare while maintaining individual rationality and incentive compatibility runs a deficit perforce, i.e., is not budget balanced. To maintain the BB property in an IR and IC mechanism, it has been necessary to compromise on the optimality of the social welfare.

In fact, there have been several attempts to design budget balanced mechanisms for particular trading domains. For instance, for double-sided auctions where both the buyers and sellers are strategic and the goods are either homogeneous or heterogeneous. See for example, McAfee R. P. A Dominant Strategy Double Auction, Journal of Economic Theory, Volume 56, pages 434-450, 1992, and Y. Bartal, R. Gonen and P. La Mura, Negotiation-range Mechanisms: Exploring the Limits of Truthful Efficient Markets, Electronic Commerce 2004: Proceedings of the 5th ACM Conference on Electronic Commerce, 2004. In McAfee, a mechanism is developed that, given valuations of buyers and sellers, produces an allocation (which are the trading players) and a matching between buyers and sellers such that the mechanism is IR, IC, and BB while retaining most of the social welfare. In another example of a trading domain, namely the distributed markets problem, goods are transported between geographic locations while incurring some constant cost for transportation. See for example, Roundy R., Chen R., Janakriraman G., and Zhang R. Q., Efficient Auction Mechanisms for Supply Chain Procurement, School of Operations Research and Industrial Engineering, Cornell University, 2001, Chu L. Y. and Shen Zuo-Jun M., Agent Competition Double Auction Mechanism, Management Science, Volume 52(8), 2006, and Babaioff M., Nisan N. and Pavlov E., Mechanisms for a Spatially Distributed Market, In Proceedings of the 5th ACM Conference on Electronic Commerce, 2004, that present mechanisms to approximate the social welfare while achieving an IR, IC and BB mechanism. In supply chain problems as a third example of a trading domain, a mechanism is developed that may bound the loss of social welfare in order to achieve the desired combination of IR, IC, and BB. See for example, Babaioff M. and Walsh W. E., Incentive-Compatible, Budget-Balanced, yet Highly Efficient Auctions for Supply Chain Formation, In Proceedings of the Fourth ACM Conference on Electronic Commerce, 2003.

Despite the works discussed above, the problem of how to design a general mechanism for implementing a trading market that achieves IR, IC, and BB independently of the trading domain remains unsolved. Furthermore, there are several trading domains where the question of how to design an IR, IC and BB mechanism which approximates the social welfare remains an unsolved problem. For example, in the important domain of combinatorial double-sided auctions, there is no known result that bounds the loss of social welfare needed to achieve budget balance. Another interesting example is the unsolved problem of how to bound the loss of social welfare that is needed to achieve budget balance in an IR and IC distributed market where the transportation edges are strategic. See for example, Babaioff M., Nisan N. and Pavlov E., Mechanisms for a Spatially Distributed Market, In Proceedings of the 5th ACM Conference on Electronic Commerce, 2004. Naturally, a solution to the problem of bounding the loss of social welfare for the BB distributed market with strategic edges has vast practical implications, for instance, to transportation networks.

What is needed is a system and method for trading markets that may bound the loss of social welfare for a wide range of trading domains. Such a system and method should be able to improve on existing solutions for problems such as double sided markets with homogenous goods, distributed markets and several kinds of supply chains. Furthermore, such a system and method should provide budget balanced mechanisms for several unsolved problems such as combinatorial double-sided auctions and distributed markets with strategic transportation edges.

### SUMMARY OF THE INVENTION

Briefly, the present invention may provide a system and method for making trading markets using generalized trade reduction. To do so, a trade reduction engine may be provided to turn the implementation of an individually rational and incentive-compatible mechanism of a market maker engine for single-valued traders making trades in a particular trading domain into an implementation of a budget balanced, individually rational and incentive-compatible mechanism that may bound the loss in social welfare. In an embodiment, two generalized trade reduction methods are presented such that, given an individually rational and incentive-compatible mechanism M that solves a trading problem in a particular domain, M may be turned into a budget balanced, individually rational and incentive-compatible mechanism. In general, the generalized trade reduction methods find procurement sets of traders and remove them in iterations until conditions of competition among remaining traders may be fulfilled for trading to occur.

In particular, given an implementation of an individually rational and incentive-compatible mechanism M for a trading market with single-valued traders, a set of traders which is closed under replacement, a dividing function, and an allocation of traders, a generalized trade reduction method may divide the allocation of traders into disjoint procurement sets and order the procurement sets by increasing value. A generalized trade reduction method may go over the procurement sets in order by increasing value to determine whether external competition exists for each trader in the procurement set that also belongs to the set of traders closed under replacement and to determine whether internal competition exists for each trader in the procurement set that does not also belong to the set of traders closed under replacement. If both external competition and internal competition exists, the procurement set and the traders in the procurement set may be kept for trading. Otherwise, the procurement set and the traders in the procurement set may be removed from trading. The traders in the procurement sets retained for trading may be charged a critical value for trading.

The two generalized trade reduction algorithms presented may accept problems in different domains. A generalized trade reduction algorithm for procurement-class domains may accept problems in the procurement-class domain. A generalized trade reduction algorithm for class domains may accept problems in either the procurement-class domain or the class domain. Trading markets representative of procurement-class domains may include double-sided auctions with homogenous goods, spatially distributed markets with non strategic edges, supply chains, single-minded combinatorial auctions, and so forth. A double sided combinatorial auction consisting of a single multi-minded buyer and multiple sellers of heterogeneous goods may be an example of a class domain.

The present invention may support many applications for making trading markets using generalized trade reduction for both procurement-class domains and class domains. The system and method may be used to improve existing budget balanced individually rational and incentive-compatible mechanisms for particular trading domains such as double-sided markets with homogenous goods, distributed markets and several kinds of supply chains, and may also be used to provide a budget balanced IR and IC mechanism for several trading domains without a previous solution such as distributed markets with strategic transportation edges and bounded paths, combinatorial double-sided auctions with bounded size of the trading group, and combinatorial double-sided auctions with bounded number of possible trading groups. Other advantages will become apparent from the following detailed description when taken in conjunction with the drawings, in which:

### BRIEF DESCRIPTION OF THE DRAWINGS

FIG. 1 is a block diagram generally representing a computer system into which the present invention may be incorporated;

FIG. 2 is a block diagram generally representing an exemplary architecture of system components for making trading markets using generalized trade reduction, in accordance with an aspect of the present invention;

FIG. 3 is a flowchart generally representing the steps undertaken in one embodiment for making trading markets using generalized trade reduction for procurement-class domains, in accordance with an aspect of the present invention; and

FIG. 4 is a flowchart generally representing the steps undertaken in one embodiment for making trading markets using generalized trade reduction for class domains, in accordance with an aspect of the present invention.

### DETAILED DESCRIPTION

### Exemplary Operating Environment

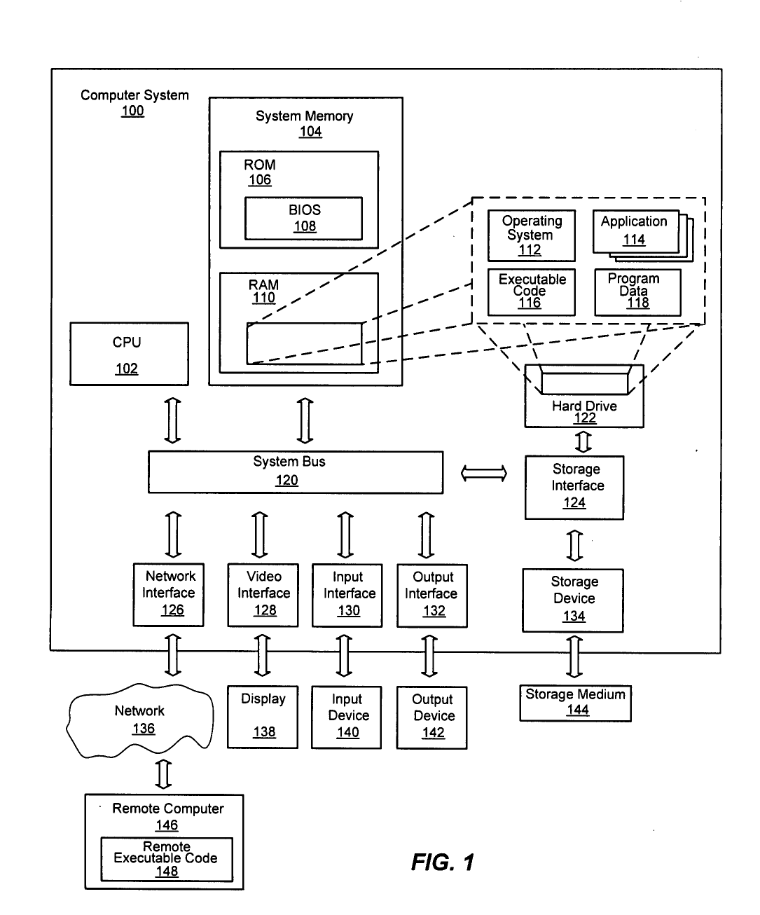

FIG. 1 illustrates suitable components in an exemplary embodiment of a general purpose computing system. The exemplary embodiment is only one example of suitable components and is not intended to suggest any limitation as to the scope of use or functionality of the invention. Neither should the configuration of components be interpreted as having any dependency or requirement relating to any one or combination of components illustrated in the exemplary embodiment of a computer system. The invention may be operational with numerous other general purpose or special purpose computing system environments or configurations.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 1, an exemplary system for implementing the invention may include a general purpose computer system 100. Components of the computer system 100 may include, but are not limited to, a CPU or central processing unit 102, a system memory 104, and a system bus 120 that couples various system components including the system memory 104 to the processing unit 102. The system bus 120 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer system 100 may include a variety of computer-readable media. Computer-readable media can be any available media that can be accessed by the computer system 100 and includes both volatile and nonvolatile media. For example, computer-readable media may include volatile and nonvolatile computer storage media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer system 100. Communication media may include computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. For instance, communication media includes wired media such as a wired network or direct-wired connection, and wireless media such as acoustic, RF, infrared and other wireless media.

The system memory 104 includes computer storage media in the form of volatile and/or nonvolatile memory such as read only memory (ROM) 106 and random access memory (RAM) 110. A basic input/output system 108 (BIOS), containing the basic routines that help to transfer information between elements within computer system 100, such as during start-up, is typically stored in ROM 106. Additionally, RAM 110 may contain operating system 112, application programs 114, other executable code 116 and program data 118. RAM 110 typically contains data and/or program modules that are immediately accessible to and/or presently being operated on by CPU 102.

The computer system 100 may also include other removable/non-removable, volatile/nonvolatile computer storage media. By way of example only, FIG. 1 illustrates a hard disk drive 122 that reads from or writes to non-removable, nonvolatile magnetic media, and storage device 134 that may be an optical disk drive or a magnetic disk drive that reads from or writes to a removable, a nonvolatile storage medium 144 such as an optical disk or magnetic disk. Other removable/non-removable, volatile/nonvolatile computer storage media that can be used in the exemplary computer system 100 include, but are not limited to, magnetic tape cassettes, flash memory cards, digital versatile disks, digital video tape, solid state RAM, solid state ROM, and the like. The hard disk drive 122 and the storage device 134 may be typically connected to the system bus 120 through an interface such as storage interface 124.

The drives and their associated computer storage media, discussed above and illustrated in FIG. 1, provide storage of computer-readable instructions, executable code, data structures, program modules and other data for the computer system 100. In FIG. 1, for example, hard disk drive 122 is illustrated as storing operating system 112, application programs 114, other executable code 116 and program data 118. A user may enter commands and information into the computer system 100 through an input device 140 such as a keyboard and pointing device, commonly referred to as mouse, trackball or touch pad tablet, electronic digitizer, or a microphone. Other input devices may include a joystick, game pad, satellite dish, scanner, and so forth. These and other input devices are often connected to CPU 102 through an input interface 130 that is coupled to the system bus, but may be connected by other interface and bus structures, such as a parallel port, game port or a universal serial bus (USB). A display 138 or other type of video device may also be connected to the system bus 120 via an interface, such as a video interface 128. In addition, an output device 142, such as speakers or a printer, may be connected to the system bus 120 through an output interface 132 or the like computers.

The computer system 100 may operate in a networked environment using a network 136 to one or more remote computers, such as a remote computer 146. The remote computer 146 may be a personal computer, a server, a router, a network PC, a peer device or other common network node, and typically includes many or all of the elements described above relative to the computer system 100. The network 136 depicted in FIG. 1 may include a local area network (LAN), a wide area network (WAN), or other type of network. Such networking environments are commonplace in offices, enterprise-wide computer networks, intranets and the Internet. In a networked environment, executable code and application programs may be stored in the remote computer. By way of example, and not limitation, FIG. 1 illustrates remote executable code 148 as residing on remote computer 146. It will be appreciated that the network connections shown are exemplary and other means of establishing a communications link between the computers may be used.

### Making Trading Markets using Generalized Trade Reduction

The present invention is generally directed towards a system and method for making trading markets using generalized trade reduction. More particularly, given an implementation of an IR and IC mechanism for a trading market with single-valued traders, an implementation of an IR, IC, and BB mechanism may be output that may bound the loss in social welfare. As used herein, a trading market may mean an information market, a securities market, a contingent claims or contract market, an event market or futures, idea futures, an auction market, and so forth. Two generalized trade reduction algorithms are presented such that given an IR and IC mechanism M that solves a trading problem in a particular domain, M may be turned into an IR, IC and BB mechanism. The algorithms presented find procurement sets and remove them in iterations until conditions of competition among remaining traders may be fulfilled for trading to occur.

As will be seen, the framework may be used to improve existing budget balanced IR and IC mechanisms for particular trading domains and may provide a budget balanced IR and IC mechanism for several trading domains without a previous solution. As will be understood, the various block diagrams, flow charts and scenarios described herein are only examples, and there are many other scenarios to which the present invention will apply.

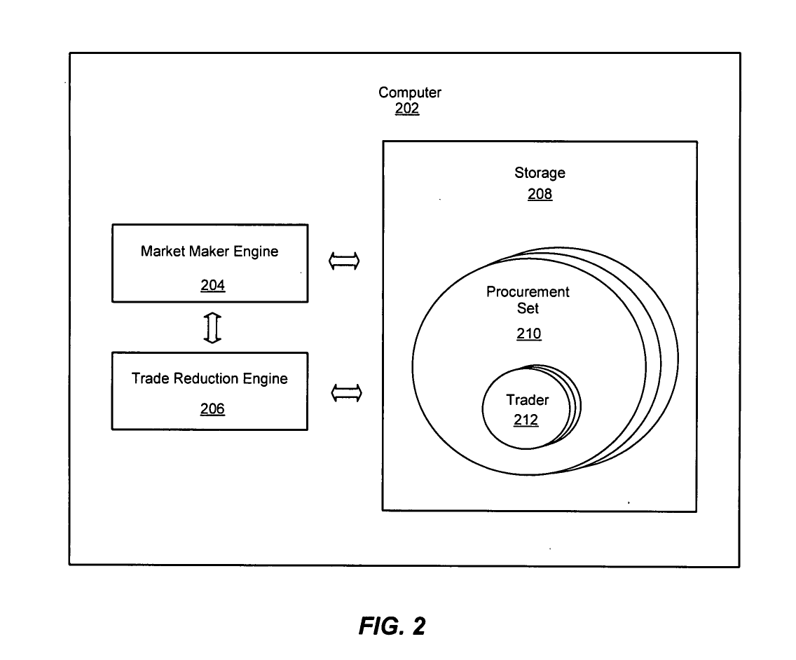

Turning to FIG. 2 of the drawings, there is shown a block diagram generally representing an exemplary architecture of system components for making trading markets using generalized trade reduction. Those skilled in the art will appreciate that the functionality implemented within the blocks illustrated in the diagram may be implemented as separate components or the functionality of several or all of the blocks may be implemented within a single component. For example, the functionality of the market maker engine 204 may be implemented within a single component with the trade reduction engine 206. Moreover, those skilled in the art will appreciate that the functionality implemented within the blocks illustrated in the diagram may be executed on a single computer or distributed across a plurality of computers for execution.

In various embodiments, a computer 202, such as computer system 100 of FIG. 1, may include a market maker engine 204 and a trade reduction engine 206 operably coupled to each other and to storage 208. In general, the market maker engine 204 and the trade reduction engine 206 may be any type of executable software code such as a kernel component, an application program, a linked library, an object with methods, and so forth. The storage 208 may be any type of computer-readable media and may store procurement sets 210 that may include one or more traders 212.

The market maker engine 204 may provide services for supporting a market for single-valued traders to make trades in a particular trading domain using an implementation of an IR and IC mechanism. In an embodiment, the traders may be either a buyer or a seller and may be assigned a real value representing the valuation of the trader. In an embodiment, the market maker engine 204 may specify an allocation of traders and payment rules that may determine an individual trader's payment in trading. A trade reduction engine 206 may provide services to turn the implementation of an IR and IC mechanism of a market maker engine for single-valued traders making trades in a particular trading domain into an implementation of an IR, IC, and BB mechanism that may bound the loss in social welfare. Each of these modules may also be any type of executable software code such as a kernel component, an application program, a linked library, an object with methods, or other type of executable software code.

There are many applications which may use the present invention for turning the implementation of an IR and IC mechanism of a market maker engine for single-valued traders making trades in a particular trading domain into an implementation of an IR, IC, and BB mechanism that may bound the loss in social welfare. For example, the present invention may be used to improve existing budget balanced IR and IC mechanisms for particular trading domains, including homogeneous double-sided auctions, distributed markets, and supply chain markets. For the homogeneous double-sided auctions, the present invention may improve on the well known solution (see McAfee R. P. A Dominant Strategy Double Auction, Journal of Economic Theory, Volume 56, pages 434-450, 1992) by allowing for some cases of no trade reduction at all. For the distributed markets and the supply chain markets, the present invention may achieve an IR, IC and BB mechanism with smaller loss on the social welfare. The present invention may also turn the model newly presented by Blume L, Easley D., Kleinberg J. and Tardos E., Trading Networks with Price-Setting Agents, In Proceedings of the 8th ACM Conference on Electronic Commerce, 2007, into a BB mechanism.

In addition to improving existing budget balanced IR and IC mechanisms for particular trading domains, the present invention may provide a budget balanced IR and IC mechanism for several trading domains without a previous solution such as distributed markets with strategic transportation edges and bounded paths, combinatorial double-sided auctions with bounded size of the trading group i.e., a buyer and its bundle goods' sellers, and combinatorial double-sided auctions with bounded number of possible trading groups.

Given an implementation of an IR and IC mechanism for a trading market with single-valued traders, an implementation of an IR, IC, and BB mechanism may be output that may bound the loss in social welfare. Consider a model of N traders divided into sets of trade. The sets of trade may be referred to as procurement sets defined as follows: a procurement set s may be the smallest set of traders that is required for trade to occur.

For example, in a double-sided auction, a procurement set may be a pair consisting of a buyer and a seller. In a combinatorial double-sided auction, a procurement set may be a buyer and several sellers. Consider the set of all procurement sets to be defined as S and assume that any allocation may be a disjoint union of procurement sets.

Each trader i, 1≦i≦n, may assign a real value vᵢ(s) to each possible procurement set s∈S. Namely, vᵢ(s) may denote the valuation of trader i on procurement set s. Assume that for each trader i, vᵢ(s) may denote i's private value and that i may be a single value trader defined as follows: if vᵢ(sⱼ)>0, then for every other sₖ, k≠j, either vᵢ(sₖ)=vᵢ(sⱼ) or vᵢ(sₖ)=0. For the ease of notation, the value of trader i may be denoted by vᵢ for any procurement set s such that vᵢ(s)>0. Consider the set Vᵢ⊂R to denote the set of all possible valuations vᵢ. The set of all possible valuations of all the traders may be denoted by V=V₁× . . . ×Vₙ. Furthermore, consider v₋ᵢ=(v₁, . . . , vᵢ₋₁, vᵢ₊₁, . . . , vₙ to denote the vector of valuations of all the traders besides trader i, and consider V₋ᵢ be the set of all possible vectors v₋ᵢ.

The value of a procurement set, s∈S, may be denoted by W(s) such that

$$W ( s ) = {\sum }_{i ∈ s} {v}_{i} ( s ) + F ( s ) ,$$

where F is some function that assigns a constant to procurement sets. For example, F may be a (non-strategic) transportation cost in a distributed market problem. Consider the size of a procurement set s be denoted as |s|.

Assume that any allocation may be a disjoint union of procurement sets, and, therefore, an allocation may partition the traders into two sets: a set of traders that trade and a set of traders that do not trade. Then consider O to denote the set of possible partitions of an allocation A into procurement sets. The value W(A) of an allocation A may denote the sum of the values of its most efficient partition into procurement sets, that may be denoted as

$$W ( A ) = {max}_{S ∈ O} {\sum }_{s ∈ S} W ( s ) .$$

Accordingly, the value W(A) of an allocation may be

$$W ( A ) = {\sum }_{i ∈ A} {v}_{i} + {max}_{S ∈ O} {\sum }_{s ∈ S} F ( s ) .$$

In the case where F is identically zero, then

$$W ( A ) = {\sum }_{i ∈ A} {v}_{i} .$$

An optimal partition S*(A) may be a partition that maximizes the above sum for an allocation A. Consider the value of A to be W(S*(A)) (note that the value can depend on F). Then the allocation A may be considered efficient if there may be no other allocation with a higher value. The efficiency of the allocation Â may be denoted by

$$\frac{W ( \hat{A} )}{W ( A )} ,$$

where A may be a maximal valued allocation. Assume w.l.o.g. that there may be no two allocations with the same value, and that ties may be decided using the identities of the traders.

A mechanism M may define an allocation and payment rules, such that M=(R,P). A payment rule P may determine i's payment pᵢ where P is a function P:V→

[symbol]

. Assume that an IR and IC mechanism requires traders to report their values. An example of such a mechanism is the VCG mechanism (see for example, Vickrey W., Counterspeculation, Auctions and Competitive Sealed Tenders, In Journal of Finance, Volume 16, pages 8-37, 1961; Clarke E. H., Multipart Pricing of Public Goods, In Journal of Public Choice, Volume 2, pages 17-33, 1971; and Groves T., Incentives in Teams, In Journal of Econometrica, Volume 41, pages 617-631, 1973.) The reported value bᵢ∈Vᵢ of trader i may represent a bid and might be different from the trader's private value vᵢ. Consider b∈V to denote the bids of all traders. An allocation rule R may then determine the allocation according to the reported values b∈V. Making a standard assumption that traders have quasi-linear utility so that when trader i trades and pays pᵢ then the trader's utility may be denoted by uᵢ(vᵢ,b₋ᵢ)=vᵢ−pᵢ,uᵢ: V [symbol]
. Assume also that traders are rational utility maximizers.

Mechanism M may be considered budget balanced (BB) if

$${\sum }_{i ∈ N} {p}_{i} \geq 0$$

for any bids b∈V. M may be considered Incentive-Compatible (IC) in dominant strategies if for any trader i, value vᵢ and any b₋ᵢ∈V₋ᵢ, uᵢ(vᵢ,b₋ᵢ)≧uᵢ(b) meaning that for any trader i, bidding vᵢ maximized i's utility over all possible bids of the other traders. M may be considered (ex-post) Individually Rational (IR) if for any trader i, value vᵢ and any b₋ᵢ∈V₋ᵢ, uᵢ(vᵢ,b₋ᵢ)≧0 meaning that for all possible bids of the other traders, trader's i utility may be non-negative. Note that since such mechanisms may be normalized IR, if a trader does not trade, then the trader pays 0 and has utility 0.

As will be seen, the generalized trade reduction algorithm presented herein may employ a commonly used payment scheme, the critical value payment scheme. A mechanism uses a critical value payment scheme, if given an allocation, the mechanism may charge traders the minimum value traders need to report to the mechanism in order to remain allocated. Consider Cᵢ to denote the critical value price computed for trader i.

Two generalized trade reduction algorithms are presented herein such that given an IR and IC mechanism M that solves a problem in some domain (different domains are formally defined below), may turn M into IR, IC and BB mechanism. The algorithms presented find procurement sets and remove them in iterations until conditions of competition among the traders may be fulfilled in the given problem. In order to present the competition conditions, several definitions may first be introduced, including definitions of a replacement set, internal competition, and external competition.

For any trader, i∈N, consider the set Rᵢ⊂N\{i} to denote a replacement set of i, if for any procurement set s∈S such that i∈s and Rᵢ∩s=0, s\{i}∪Rᵢ∈S. For example, in a (homogeneous) double-sided auction the replacement set for any buyer may be simply any other buyer. In an auction for transportation slots, the replacement set of an edge may be a path between the endpoints of the edge. Note that a set may replace a single trader. Furthermore, this relationship may be transitive but not necessarily symmetric. If i may be a replacement set for j, it is not necessarily true that j may be a replacement set for i.

For any allocation A, procurement set s⊂A, and any i∈S, consider Rᵢ(A,s) to denote an internal competition for i with respect to A and s, if Rᵢ(A,s)⊂N\A may be a replacement set for i such that T=s\{i}∪Rᵢ(A,s)∈S and W(T)≧0.

For any allocation A, procurement set s⊂A, and any i∈S, consider Eᵢ(A,s) to denote an external competition for i with respect to A and s, if Eᵢ(A,s)⊂N\A may be a set such that T=s\{i} ∪Eᵢ(A,s)∈S and W(T)≧0.

Assume, without loss of generality, that there may be no ties between the values of any allocations, and, in particular, there may be no ties between values of procurement sets. In the case of ties, ties can be broken by using the identities of the traders. So, for any allocation A, procurement set s and trader i with external competition Eᵢ(A,s), there may exist exactly one set representing the maximally valued external competition. Accordingly, a set X⊂N may be considered closed under replacement if ∀i∈X, then Rᵢ⊂X.

The set X may be used to denote a set closed under replacement that may satisfy the conditions of competition needed for a mechanism to maintain IC, IR and BB. Furthermore, assume that all of the sets which define competition required for IC, IR and BB in a mechanism M to be closed under replacement. Given a set X⊂N that is closed under replacement, consider a mechanism to be defined as an X-external mechanism, if:

1. each trader i∈X may have an external competition;

2. each trader i∉X may have an internal competition;

3. for all traders i₁, . . . , iₜ∈s\X, there may exist Rᵢ_{ₗ}(A,s), . . . , Rᵢ_{ₜ}(A,s) such that for every i_{z}≠i_{q}, Rᵢ_{_{z}}(A,s)∩Rᵢ_{_{q}}(A,s)=Ø; and

4. for every procurement set s∈S, then s∩X≠Ø.

For general domains, the choice of X may be crucial in an embodiment. In fact, even for the same domain, the social welfare (and revenue) can vary widely depending on how X is defined. In general, X should be chosen as small as possible.

The two generalized trade reduction algorithms presented may ensure that for any allocation, there may be the desired types of competition. So, given a mechanism M that is IC and IR with allocation A, the generalized trade reduction algorithms may turn M into an X-external mechanism. The two generalized trade reduction algorithms may utilize a dividing function D to divide allocation A into disjoint procurement sets. The algorithms may order the procurements sets defined by D in order of increasing value. For any procurement set, there may be a desired type of competition that depends on the traders who compose the procurement set. The generalized trade reduction algorithms may go over the procurement sets in order (from the smallest to the largest) and may remove any procurement set that does not have the desired competition. The reduction of procurement sets may also be referred to as a trade reduction.

Formally, consider D to denote a dividing function if for any allocation A and the traders' value vector v, D may divide the allocation into disjoint procurements sets s₁, . . . , sₖ such that ∪sⱼ=A and for any trader i with value vᵢ if i∈sⱼ₁ and t∈sⱼ₂ such that j₁≧j₂ then for any value v′ᵢ≧vᵢ of trader i and division by D into s′₁, . . . , s′_{k′}, such that i∈s′_{j′}_{₁} and t∈s′_{j′}_{₂}, then j′ᵢ≧j′₂.

The two generalized trade reduction algorithms presented may accept problems in different domains. The first formal domain definition is as follows. A domain may be a class domain, if for all i∈N and all replacement sets of i, Rᵢ, |Rᵢ|=1 and for all i, j, i≠j if i=Rᵢ then j=Rᵢ. Intuitively, this may mean that replacement sets are of size 1 and the replacing relationship is symmetric. The class of a trader i may be defined as the set of the trader's replacement sets and the class of trader i may be denoted by [i]. It is important to note that since replacement sets are transitive relations and since class domains also impose symmetric relations on the replacement sets, the class of a trader i, [i] is actually an equivalence class for i.

The second formal domain definition is as follows. A domain may be a procurement-class domain, if the domain is a class-based domain and if for any trader i such that there exists two procurement sets s₁, s₂ (not necessarily trading simultaneously in any allocation) such that i∈s₁ and i∈s₂, then there exists a bijection ƒ:s₁→s₂ such that for any j∈s₁, ƒ(j) is a replacement set for j in s₂. A (homogeneous) double-sided auction, for instance, may be a procurement-class based domain. For the (homogeneous) double-sided auction, each procurement set consists of a buyer and a seller.

The double sided combinatorial auction consisting of a single multi-minded buyer and multiple sellers of heterogeneous goods, may be a class domain (as we have a single buyer) but not a procurement-class domain. In this case, the buyer may be a class and each set of sellers of the same good may be a class. However, for a buyer there may be no bijection between the different the procurement sets of the bundles of goods the buyer may be interested in.

As another example, the spatial-distributed market with strategic edges may not be a class-based domain and, therefore, not a procurement-class domain. For instance, even for a fixed buyer and a fixed seller, there may be two different procurement sets consisting of different paths between the buyers and sellers.

Because of the different domains, two generalized trade reduction algorithm may be developed, each for accepting problems in the different domains. A generalized trade reduction algorithm for procurement-class domains may accept problems in the procurement-class domain. A generalized trade reduction algorithm for class domains may accept problems in either domain.

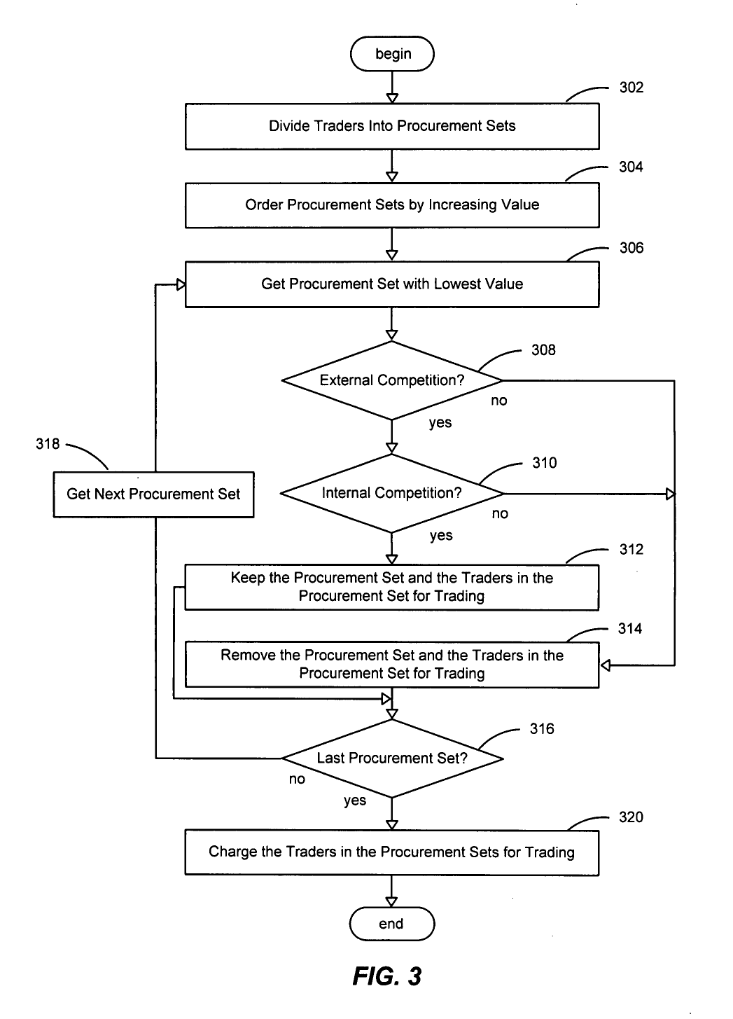

FIG. 3 presents a flowchart generally representing the steps undertaken in one embodiment for making trading markets using generalized trade reduction for procurement-class domains. For example, the following trading markets may be representative of procurement class domains: double-sided auctions with homogenous goods, spatially distributed markets with non strategic edges, supply chains, single-minded combinatorial auctions, and so forth.

In a double-sided auctions with homogenous goods, there may be two classes: a class of buyers and a class of sellers. Each procurement set may include a single buyer and a single seller. Since every pair of buyer and seller may be a valid procurement set (albeit possible with negative value), a double-sided auction may represent a procurement class domain. In this domain, the constant assigned to the procurement sets may be F=0.

Like the double-sided auctions with homogenous goods, there may be two classes in a spatially distributed market with non-strategic edges. For instance, there may be a class of buyers and a class of sellers; and each procurement set may include a single buyer and a single seller. The sellers and buyers may be represented by nodes in a graph and the function F may be the distance between two nodes (length of the edge) representing the transport costs. These costs may differ between different pairs of buyer and seller.

General supply chains, which need not be a procurement class domain, may be turned into a procurement class domain. And in the context of single-minded combinatorial auctions, each seller may sell a single good and each buyer wants a set of goods. Thus, there may be two classes: the sets of sellers selling the same good and the buyers who desire the same bundle. A procurement set may include a single buyer and a set of sellers who can satisfy that buyer.

Given an implementation of an IR and IC mechanism M for a trading market with single-valued traders, a set X⊂N which is closed under replacement, a dividing function D, and allocation A, the steps of a generalized trade reduction engine for procurement-class domains may operate by performing the steps of FIG. 3 to turn the implementation of an IR and IC mechanism M of a market maker engine for single-valued traders making trades in a particular procurement-class trading domain into an implementation of an IR, IC, and BB mechanism that may bound the loss in social welfare.

At step 302, traders may be divided into procurement sets. In an embodiment, the traders may be divided into procurement sets by using the dividing function D to divide A into procurement sets s₁, . . . , sₖ∈S. An optimal dividing function may be calculated for procurement class domains in polynomial time by first defining a special dividing function D′₀ recursively as follows: at stage j, D′₀ may divide the traders into two sets Aⱼ and A′ⱼ such that Aⱼ is a procurement set, A′ⱼ can be divided into a disjoint union of procurement sets, and Aⱼ may have the minimal value from all possible such partitions. Next, define sⱼ=Aⱼ and recursively invoke D′₀ and A′ⱼ until A′ⱼ=Ø.

After dividing the traders into procurement sets at step 302, the procurement sets may be ordered at step 304 by increasing value. The procurement set with the lowest value may be obtained from the procurement sets at step 306. It may be determined at step 308 whether there may be external competition. If so, then it may be determined at step 310 whether there may be internal competition. If it is determined that there may be internal competition, then the procurement set (and the traders in the procurement set) may be kept at step 312 for trading. Otherwise, if it was determined at step 308 that there may not be external competition or if it was determined at step 310 that there may not be internal competition, then the procurement set (and the traders in the procurement set) may be removed at step 314 from trading. Thus, if for every i∈sⱼ∩X there may be external competition and every i∈sⱼ\X there may be internal competition, then sⱼ may be kept. Otherwise, the trade sⱼ may be reduced, i.e., every i∈sⱼ may be removed from the allocation.

At step 316, it may be determined whether the last procurement set has been processed. If not, then the next procurement set may be obtained at step 318 and processing may continue at step 306. Otherwise, the traders in the procurement sets retained for trading may be charged at step 320 and then processing may be finished for making trading markets using generalized trade reduction for procurement-class domains. In an embodiment, the traders in the procurement sets retained for trading may be charged the critical value for trading, and traders removed from trading may be charged nothing.

An important reason why the generalized trade reduction engine works for the procurement-class domains is that each trader's possibility of being reduced is monotonic. By the definition of a dividing function, if a trader i∈sⱼ increases his value, i can only appear in later procurement set s′ⱼ and hence has a higher chance of having the desired competition.

Therefore, the chance of i lacking the requisite competition is decreased. Since the domain is a procurement class domain, all other traders t≠i, t∈s′ⱼ are also more likely to have competition since members of their class continue to appear before i, and hence the likelihood that i will be reduced is decreased. Since a necessary and sufficient condition for the mechanism to be IC is monotonicity, the generalized trade reduction algorithm is IC for procurement-class domains.

However, for domains that may not be procurement class domains, this does not suffice even if the domain is a class domain. Although all members of sⱼ continue to have the required competition, it is possible that there may be members of s′ⱼ who do not have analogues in sⱼ who do not have competition. Hence i might be reduced after increasing his value which may mean that mechanism is not IC. Therefore a different algorithm may be used for non-procurement class domains.

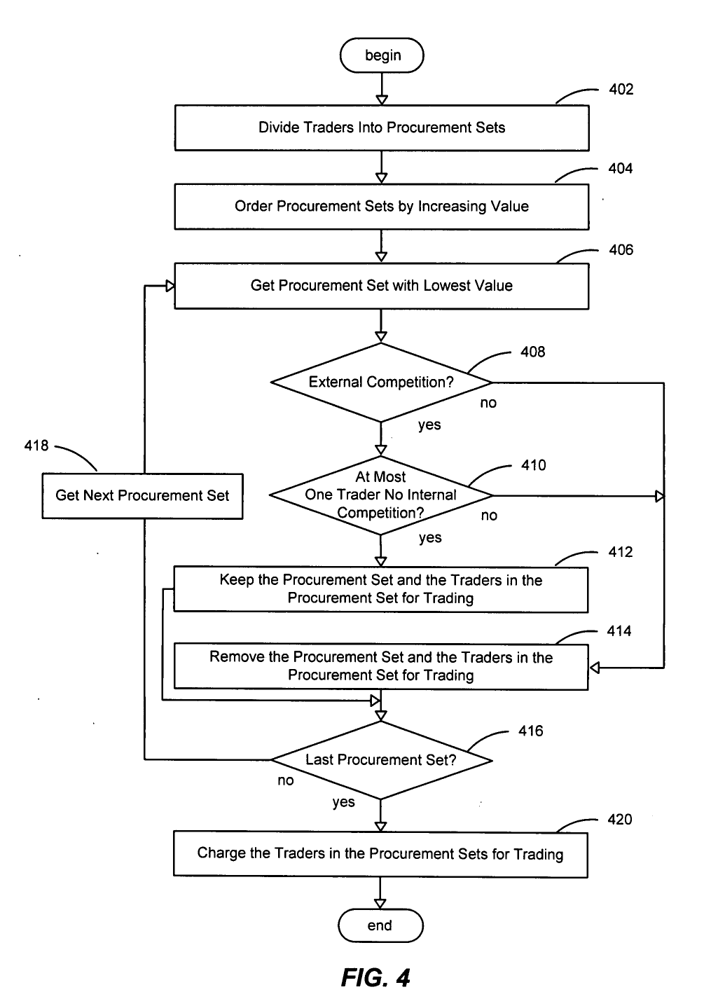

FIG. 4 presents a flowchart generally representing the steps undertaken in one embodiment for making trading markets using generalized trade reduction for class domains. At step 402, traders may be divided into procurement sets. In an embodiment, the traders may be divided into procurement sets by using the dividing function Dₒ to divide A into procurement sets s₁, . . . , sₖ∈S. The generalized trade reduction algorithm for class domains requires a special dividing function in order to maintain the IC property. Although the restriction to this special dividing function may appear stringent, the dividing function used is a generalization of the way that procurement sets are chosen in procurement-class based domains. In an embodiment, assume that F=0.

The dividing function for general class domains may be defined by looking at possible dividing functions, and for each dividing function Dᵢ and each set of bids, the generalized trade reduction algorithm may yield a welfare that is a function of the bids and the dividing function. Consider D₀ to be the dividing function that may divide the traders into sets such that the welfare that the generalized trade reduction algorithm finds may be maximal. Formally, consider θ to be the set of all dividing functions D. Consider GTR1(D, b̅)) to denote the welfare achieved by the mechanism produced by the generalized trade reduction algorithm when using dividing function D and a set of bids b̅. Then consider D₀ to be defined as D₀( b̅)=arg max_{D∈θ}((GTR1(D, b̅)).

After dividing the traders into procurement sets at step 402, the procurement sets may be ordered at step 404 by increasing value. The procurement set with the lowest value may be obtained from the procurement sets at step 406. It may be determined at step 408 whether there may be external competition. If so, then it may be determined at step 410 whether there may be at most one trader that may not have an internal competition. If it is determined that there may be at most one trader that may not have an internal competition, then the procurement set (and the traders in the procurement set) may be kept at step 412 for trading. Otherwise, if it was determined at step 408 that there may not be external competition or if it was determined at step 410 that there may not be at most one trader that may not have an internal competition, then the procurement set (and the traders in the procurement set) may be removed at step 414 from trading. Thus, if for every i∈sⱼ∩X there may be external competition and there may be at most one i∈Sⱼ that does not have an internal competition, then sⱼ may be kept. Otherwise, the trade sⱼ may be reduced, i.e., every i∈sⱼ may be removed from the allocation.

At step 416, it may be determined whether the last procurement set has been processed. If not, then the next procurement set may be obtained at step 418 and processing may continue at step 406. Otherwise, the traders in the procurement sets retained for trading may be charged at step 420 and then processing may be finished for making trading markets using generalized trade reduction for class domains. In an embodiment, the traders in the procurement sets retained for trading may be charged the critical value for trading, and traders removed from trading may be charged nothing.

Thus the present invention may provide an implementation of an IR, IC, and BB mechanism that may bound the loss in social welfare. The output mechanism achieves welfare that is close to optimal for a wide range of trading domains. In particular, the present invention may improve on existing solutions for problems such as double sided markets with homogenous goods, distributed markets and several kinds of supply chains. Furthermore, the present invention may provide a budget balanced IR and IC mechanism for several trading domains without a previous solution such as distributed markets with strategic transportation edges and bounded paths, combinatorial double-sided auctions with bounded size of the trading group i.e., a buyer and its bundle goods' sellers, and combinatorial double-sided auctions with bounded number of possible trading groups.

As can be seen from the foregoing detailed description, the present invention provides an improved system and method for making trading markets using generalized trade reduction. The present invention may support many applications for making trading markets using generalized trade reduction for both procurement-class domains and class domains. The system and method may be used to improve existing budget balanced IR and IC mechanisms for particular trading domains and may also be used to provide a budget balanced IR and IC mechanism for several trading domains without a previous solution. As a result, the system and method provide significant advantages and benefits needed in contemporary computing.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. A computer system for a trading market, comprising:
a trade reduction engine for providing services to implement an individually rational, incentive-compatible, and budget balanced mechanism for a trading market from output of a market maker engine implementing an individually rational and incentive-compatible mechanism; and
a storage operably coupled to the trade reduction engine for storing procurement sets of traders that may be reduced by the trade reduction engine.

2. The system of claim 1 further comprising the market maker engine implementing the individually rational and incentive-compatible mechanism operably coupled to the trade reduction engine for providing services for supporting a market for single-valued traders to make trades.

3. A computer-readable medium having computer-executable components comprising the system of claim 1.

4. A computer-implemented method of operating a trading market, comprising:
dividing a plurality of traders into a plurality of disjoint procurement sets;
obtaining a procurement set of lowest value from the plurality of procurement sets;
determining external competition exists for each trader in the procurement set that also belongs to a set of traders closed under replacement;
determining internal competition exists for each trader in the procurement set that does not also belong to the set of traders closed under replacement; and
charging the traders in the procurement set for trading.

5. The method of claim 4 further comprising ordering the procurement sets by increasing value.

6. The method of claim 4 further comprising:
obtaining another procurement set from the plurality of procurement sets;
determining external competition does not exist for each trader in the another procurement set that also belongs to the set of traders closed under replacement; and
removing the traders in the another procurement set from trading.

7. The method of claim 4 further comprising:
obtaining another procurement set from the plurality of procurement sets;
determining internal competition does not exist for each trader in the another procurement set that does not also belong to the set of traders closed under replacement; and
removing the traders in the another procurement set from trading.

8. The method of claim 4 further comprising receiving the set of traders closed under replacement.

9. The method of claim 4 further comprising receiving the plurality of traders from an allocation determined by an individually rational and incentive-compatible mechanism for making a trade.

10. The method of claim 4 wherein dividing the plurality of traders into a plurality of disjoint procurement comprises using a dividing function to divide the plurality of traders into a plurality of monotonically increasing procurement sets.

11. The method of claim 4 wherein charging the traders in the procurement set for trading comprises charging the traders the minimum value the traders need to report in order to remain allocated for trading.

12. A computer-readable medium having computer-executable instructions for performing the method of claim 4.

13. A computer system for a trading market, comprising:
means for receiving a plurality of traders from an allocation determined by an individually rational and incentive-compatible mechanism;
means for dividing the plurality of traders into a plurality of disjoint procurement sets;
means for receiving a set of traders closed under replacement;
means for selecting a procurement set from the plurality of procurement sets; and
means for determining whether external competition exists for each trader in the procurement set that also belongs to the set of traders closed under replacement.

14. The computer system of claim 13 further comprising means for determining whether internal competition exists for each trader in the procurement set that does not also belong to the set of traders closed under replacement.

15. The computer system of claim 14 further comprising means for charging the traders in the procurement set for trading if both external competition exists for each trader in the procurement set that also belongs to the set of traders closed under replacement and internal competition exists for each trader in the procurement set that does not also belong to the set of traders closed under replacement.

16. The computer system of claim 13 further comprising means for removing the traders in the procurement set from trading if external competition does not exist for each trader in the procurement set that belongs to the set of traders closed under replacement.

17. The computer system of claim 14 further comprising means for removing the traders in the procurement set from trading if internal competition does not exist for each trader in the procurement set that does not also belong to the set of traders closed under replacement.

18. The computer system of claim 13 further comprising:
means for selecting another procurement set from the plurality of procurement sets;
means for determining whether external competition exists for each trader in the another procurement set that also belongs to the set of traders closed under replacement; and
means for determining whether internal competition exists for each trader in the another procurement set that does not also belong to the set of traders closed under replacement.

19. The computer system of claim 13 wherein means for dividing the plurality of traders into a plurality of disjoint procurement sets comprises means for dividing the plurality of traders into a plurality of disjoint procurement sets for a trading market in a class domain.

20. The computer system of claim 13 further comprising means for determining whether internal competition exists for at most one trader in the procurement set that does not also belong to the set of traders closed under replacement.
